(19) United States
(12) Patent Application Publication
(10) Pub. No.: US 2016/0128301 A1
(43) Pub. Date: May 12, 2016

(54) MODULAR CONTAINMENT SYSTEM

(71) Applicant: BioBubble Pets, LLC, Boca Raton, FL (US)

(72) Inventor: Alberto J. Venezia, Boca Raton, FL (US)

(73) Assignee: BioBubble Pets, LLC, Boca Raton, FL (US)

(21) Appl. No.: 14/935,181

(22) Filed: Nov. 6, 2015

Related U.S. Application Data
(60) Provisional application No. 62/076,885, filed on Nov. 7, 2014.

(51) Int. Cl. A01K 1/03; A01K 63/00

(52) U.S. Cl. CPC A01K 1/03; A01K 63/003

(57) ABSTRACT

A wildlife containment system includes a first modular unit positionable on a surface and configured to contain a first wildlife habitat, the first modular unit including a first set of outer supports located at corner regions of the first modular unit, a second modular unit configured to contain a second wildlife habitat, the second modular unit including a second set of outer supports located at corner regions of the second modular unit, and a support structure received within apertures in the first and second sets of outer supports, the support structure maintaining the first and second modular units in a fixed relationship such that the second modular unit is supported at least in part by the first modular unit and suspended above the surface.

### CROSS REFERENCE TO RELATED APPLICATIONS

This application claims priority to U.S. Provisional Patent Application No. 62/076,885, filed Nov. 7, 2014, the contents of which are hereby incorporated reference in their entirety.

### BACKGROUND

Habitat diorama in general may include aquariums used for keeping fish, or homes for keeping reptiles or other wildlife, and have generally been known for some time. Many are typically of quadrangular construction, with a plurality of viewing panels being joined together by glue or other mechanical fastening mechanisms to form a main tank. Lights and other equipment are generally mounted directly on the top or on one or more viewing panels. Some known examples include aquariums for keeping fish, or homes for non-aqueous based wildlife such as reptiles, gerbils, and the like.

These aquariums or other wildlife homes typically suffer from several drawbacks which inhibit their use, maintenance, and enjoyment. Known tank designs generally use a single tank containing aquatic or other wildlife. As a result, tank designs are generally limited to varying sizes and shapes of a single tank. Moreover, the limited designs reduce the ways the tanks can be used as decorative elements of a living space.

Accordingly, there is a need for a wildlife containment system that allows other configurations and facilitates use in a wide variety of spaces.

### BRIEF DESCRIPTION OF THE DRAWINGS

FIG. 1 is a an assembly of two modular containment units, where one is assembled and one is shown disassembled;

FIG. 2 is an illustration of three modular containment units after assembly in a stepped configuration;

FIG. 3 is an illustration of an assembly showing three modular containment units from FIG. 2 during the assembly into the stepped configuration;

FIG. 4 is an illustration of an assembly showing three modular containment units, with two positioned orthogonally to one another and suspended above a base surface;

FIG. 5 is an illustration of two modular containment units that are in communication with one another via a conduit; and

FIGS. 6A-6G illustrate a number of exemplary configurations for the modular containment units.

### DETAILED DESCRIPTION

Reference in the specification to “one embodiment,” “an embodiment,” “an example,” or the like, means that a particular feature, structure, or characteristic described in connection with the embodiment is included in at least one exemplary illustration. The appearances of the phrase “in one example,” etc. in various places in the specification are not necessarily all referring to the same exemplary illustration.

Various exemplary illustrations are provided herein of an exemplary containment system which includes a plurality of modular containment units for forming habitat diorama. The containment units may each comprise a generally closed tank as a wildlife habitat, and may be configured collectively in any number of positions relative to one another. For example, support structures may be provided that position the modular containment units with respect to one another, allowing the modular containment units to be stacked upon each other, placed horizontally adjacent one another, or placed in a “stepped” configuration, as will be described further below. The modular containment units may also be placed in generally three dimensional arrangements with respect to one another, as well. For instance, the disclosed modular containment units may be assembled having not only stepped structures in the diorama, but subsequently stacked modular containment units may be placed fore or aft of a previous modular containment unit to create a three dimensional arrangement of units that may be custom fit to a specific location having limited space.

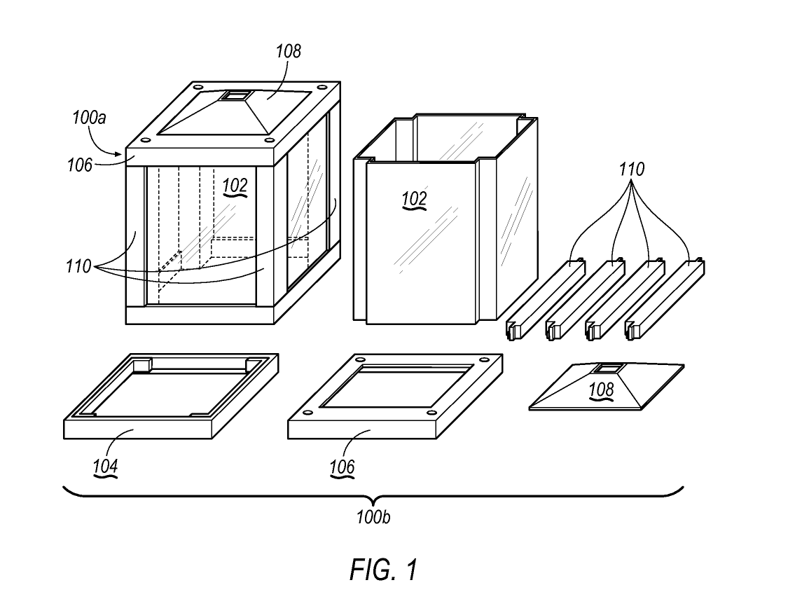

Referring now to FIGS. 1-3, an exemplary wildlife modular containment system 100 is illustrated according to an exemplary illustration. Containment system 100 includes a plurality of modular containment units 100a, 100b, 100c, etc. Although three units 100a, 100b, 100c are illustrated, any number of units may be employed.

Each of the modular containment units 100a, 100b, 100c includes a wildlife habitat or tank unit 102, which defines a generally closed volume therein. Wildlife habitat includes but is not limited to a habitat in which residents such fish, reptiles, gerbils, and other animals may reside for human enjoyment. A wildlife habitat generally refers to an environment that is arranged such that its residents can safely reside without human interaction other than the opportunity for humans to enjoy viewing the resident's life within the habitat. The tank unit 102 may thus be used to contain fish, wildlife animals or reptiles, materials to support the life of the resident (water for fish, feed bowls and sand or dirt for non-fish residents, as examples), and/or decorative elements. The tank unit 102 may be partially or completely transparent through the walls thereof, to allow the interior volume to be visible from outside the tank unit 102. Accordingly, the modular containment units 100a-100c may be particularly useful as fish tanks or containment systems for other wildlife. A lid 108 may be used to generally enclose the tank unit 102. While the exemplary modular containment units 100a-100c and tank units 102 thereof are generally shown as cubes, other shapes may be employed, such as cuboids (having 6 faces, 12 edges, and 8 vertices, all faces being rectangular) or hexagonal prisms (having 8 faces, 18 edges, and 12 vertices, with two faces at either end as hexagons and the rest of the faces rectangular), as examples.

Each of the tank units 102 may be positioned using outer supports 110, which may be positioned vertically at each corner of the tank unit 102 upon assembly. An upper support 106 and base section or lower support 104 may cooperate to define upper and lower boundaries for the tank unit 102. Upper support 106 is illustrated as a generally square shape, but may take the shape of tank unit 102 to provide structural support thereto and to frame in an upper portion of tank unit 102. Outer supports 110 are located at the corners of tank unit 102 and also provide structure that engages with base section 104 and with upper support 106. The tank unit 102, outer supports 110, upper support 106, and lower support 104 may be formed of any structural material, e.g., a plastic material that may be clear or transparent for tank unit 102. Thus, one or more of the modular containment units is transparent, or includes one or more transparent walls, such that wildlife within one of wildlife habitats is viewable from outside the modular containment units 100a-100c.

The exemplary modular containment system 100 may employ support structures 112 as separate components that are used to allow positioning a plurality of modular containment units 100a-100c in a variety of different fixed relative positions. The support structures 112 may be formed of any material, e.g., from plastic or a metal material that is stamped or cast. Once assembled, wildlife containment system 100 includes a first modular unit 100a positionable on a surface 118 and configured to contain a first wildlife habitat, and a second modular unit 100b configured to contain a second wildlife habitat. System 100 includes support structures 112a, 112b received in the first and second modular units 100a, 100b, the support structures 112a, 112b maintaining the first and second modular units 100a, 100b in a fixed relationship such that the second modular unit 100b is supported at least in part by the first modular unit 100a and suspended above the surface 118.

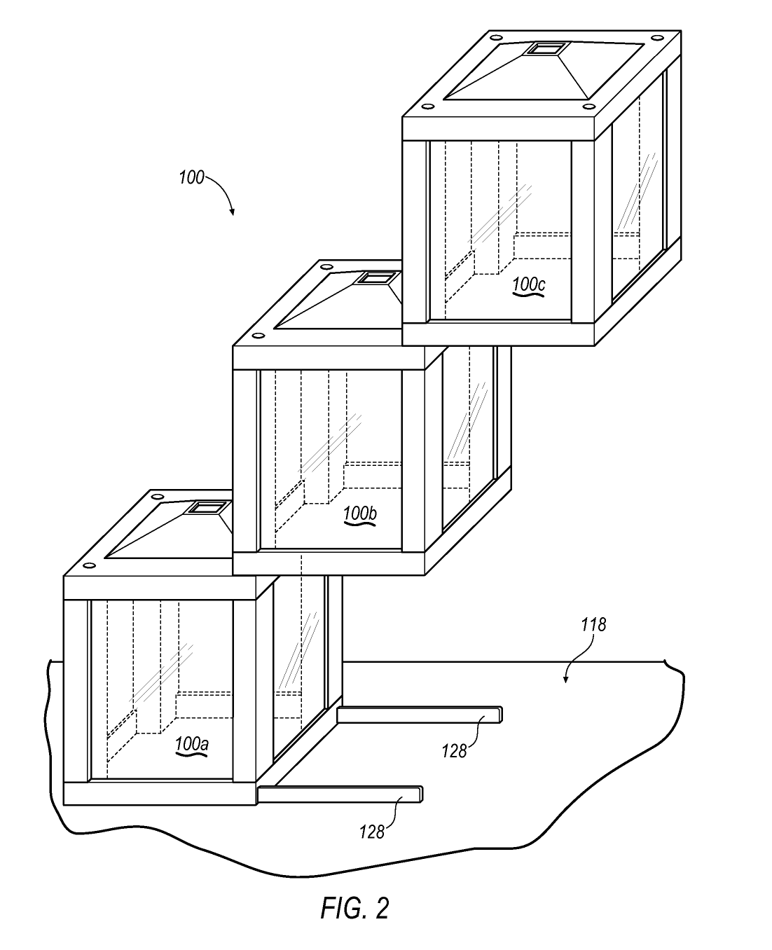

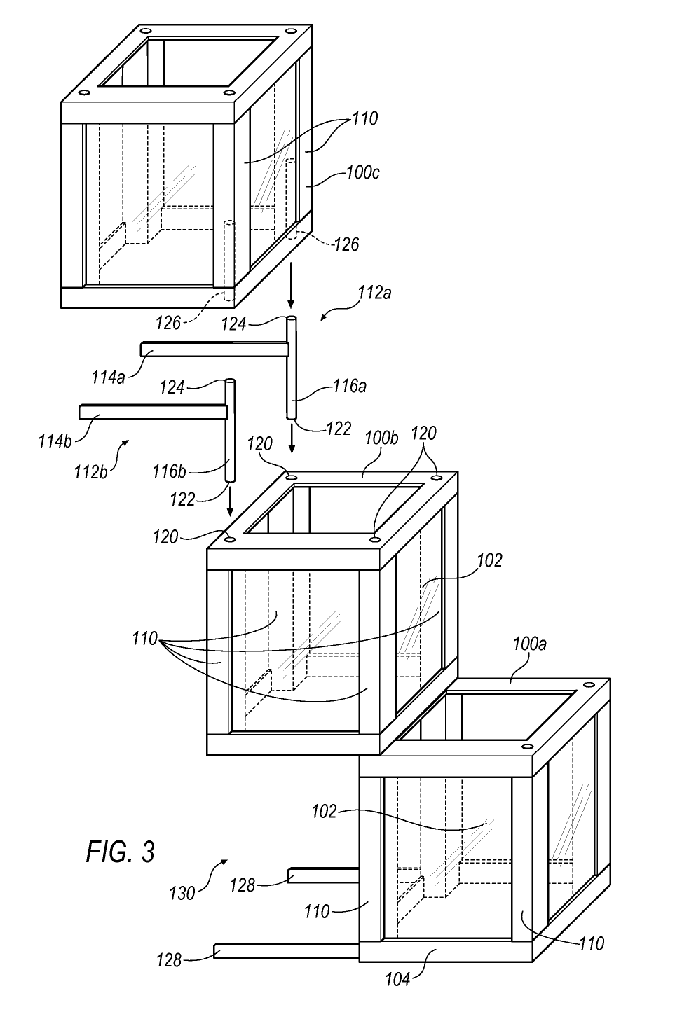

As seen in FIGS. 2 and 3, support structures 112 in general may be used to position the modular containment units 100a-100c relative to one another and on surface 118, which may be a table top, as one example. As shown in FIG. 3 support structures 112a, 112b may each include a first arm or cross member 116a, 116b, as well as a second arm or base member 114a, 114b positioned orthogonally to the first arms 116a, 116b, respectively. The support structures 112a, 112b may be received within holes or apertures 120 of the modular containment units 100a-100c to position the units 100a-100c relative to one another and generally support the modular containment units 100a-100c. For example, as seen in FIG. 3 a first end 122 of the first arms 116 of the support structures 112a, 112b are each received within apertures 120 of two of the vertically extending outer supports 110 of the modular tank unit 100b, while a second end 124 of the first arms 116 are each received within apertures 126 (shown in phantom) of the outer supports 110 of modular containment unit 100c. Additionally, the second arms or base members 114 each extend horizontally to support the modular containment unit 100c in a “stepped” configuration where it is positioned vertically above and horizontally adjacent the modular containment unit 100b. Similarly, additional support structures 112 (not visible) may be provided which support the modular containment unit 100b with respect to the modular containment unit 100a, which is positioned on floor or table surface 118. Finally, support extenders 128 may be included which provide horizontal support with respect to the assembled units 100a-100c, thereby preventing tipping of the assembled structure.

Thus, in one example, a wildlife containment system includes first modular unit 100a positionable on surface 118 and configured to contain a first wildlife habitat 102a, the first modular unit 100a including a first set of outer supports 110 located at corner regions of the first modular unit 100a. Second modular unit 100b is configured to contain a second wildlife habitat 102b, the second modular unit 100b includes a second set of outer supports 110 located at corner regions of the second modular unit 100b. Support structures 112 are received within apertures 120, 126 in the outer supports 110. The support structures 112 maintain the first and second modular units 110a, 110b in a fixed relationship such that the second modular unit 110b is supported at least in part by the first modular unit 110a and suspended above surface 118. That is, as shown in FIG. 3, a space 130 is formed between a bottom of the second modular unit 100b and surface 118. Support extenders 128 are positionable within base section 104 of the first modular unit 100a and configured to engage surface 118 and provide support for the first modular unit 100a to prevent the containment system 100 from tipping over.

In the illustrated example, support structure 112 in general is a T-shaped support having base member 114 attached to cross member 116, the cross member 116 having first end 122 received within apertures 120 of modular unit 100a, and second end 124 received within apertures 126 of another or second modular unit 100b such that at least a portion of a weight of the second modular unit 100b is supported by the base member 114 of the T-shaped support 112.

The support structures 112 may define complementary shapes with respect to the outer supports 110, thereby inhibiting or preventing relative movement or rotation of the support structures 112 and outer supports 110 with respect to each other. Merely as an example, the arms of the support structures 112 may define a generally quadrangular or square shape. Moreover, multiple support structures 112 may be used to secure adjacent modular containment units 100 in a fixed position relative to one another.

The support structures 112 may generally be hidden within the apertures 120, 126 of the outer supports 110 upon assembly. For example, the first arms 116 of the support structures 112a, 112b are generally hidden within the outer supports 110 of the adjacent modular containment units 100c, 100b, while the second arms 114 of the support structures 112a, 112b are generally hidden either within or below the lower support 104 of the modular containment unit 100c. The support structures 112 may be configured to allow pivoting within the outer supports 110 of the modular containment units 100. For example, the generally round or cylindrical arm portion or cross member 116 of support structure 112 may allow the support structure 112 to turn or pivot within the outer support 110, while a platform fixed (not shown) upon the arm may provide lateral support for an adjacent modular containment unit 100. In such fashion, modular containment system 100 may be assembled having a generally three dimensional arrangement of modular units. For example, referring to FIG. 2, although modular units 110a-c are shown in a generally two-dimensional stepped arrangement, they instead may be assembled with modular unit 100c positioned either directly forward or aft of modular unit 100b by using the respective apertures 120 in the forward or aft locations of modular unit 100b.

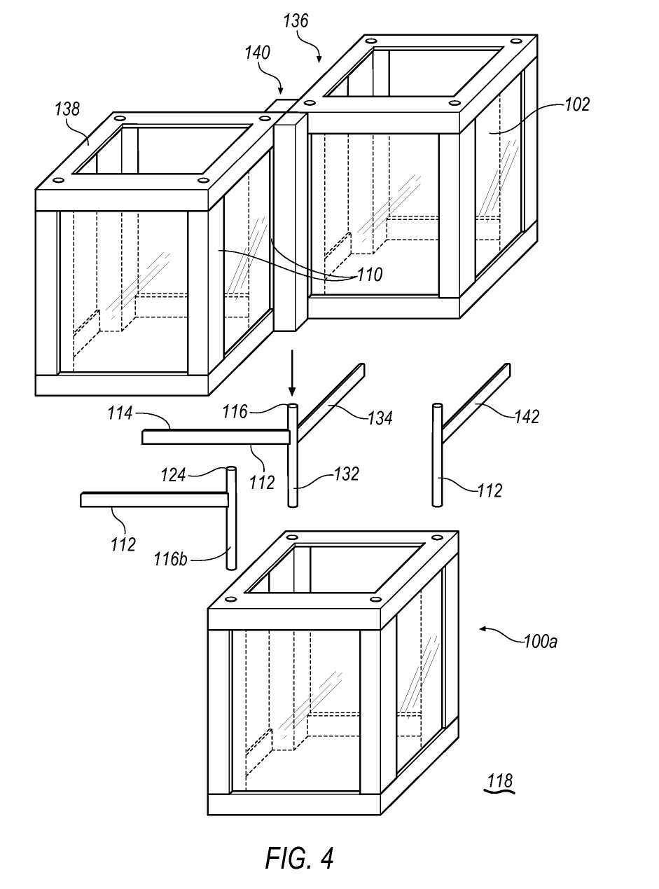

Or, in another example and as illustrated in FIG. 4, one of the support structures 112, illustrated also having identifier 132, may include cross-member 116 and base member 114, and also a second base member 134 that is transverse or approximately orthogonal to base member 114. In such fashion, second base member 134 supports a third modular unit 136 that is configured to contain a tank unit or wildlife habitat 136, the modular containment unit 136 supported at least in part by first modular unit 100a and suspended above the surface 118. In one example, cross-member 116 is received within apertures in a modular containment unit 138 and in this example unit 136 merely rests upon or is otherwise affixed or attached to second base member 134 and a base member 142. In another example (not illustrated) a support structure that is common to both modular containment units 136, 138 and in a common region to both 140, an aperture contained therein receives cross-member 116 to provide support for both units 136, 138.

Thus, modular containment units 100 may be positioned in an angled or rotated configuration with respect to one another. In other exemplary illustrations, a support arm may be bendable or otherwise moveable to allow movement or adjustment of the modular containment units 100 relative to one another.

The lower support 104 of each modular containment unit 100 may generally space a bottom of the tank unit 102 vertically away from a surface or adjacent modular containment unit 100. As such the lower support 104 may be used to conceal a lighting device or other equipment for supporting wildlife, e.g., fish, that is kept within the tank unit 102. In such examples where a lighting device is used to illuminate a tank unit 102 from below, e.g., from within the lower support 104, a collar or wall may be provided to block sand or gravel from a portion of the bottom surface of the tank unit 102, thereby allow light to pass upwardly into the tank unit 102. Alternatively, or in addition, one or more lighting devices (e.g., light emitting diodes or other lighting devices) may be positioned in an upper area of the modular containment unit, e.g., within the upper support 106 or beneath lid 108. Further, it is contemplated that support structures 112 may also be used to support items other than another modular unit. Apertures 120 with support structures 112 positioned therein provide convenient supports for supporting other items such as lighting, signage, and the like. Thus, support structures in apertures 120 may be used to support not only a subsequent modular containment unit, but may be used for convenient positioning of other items as well.

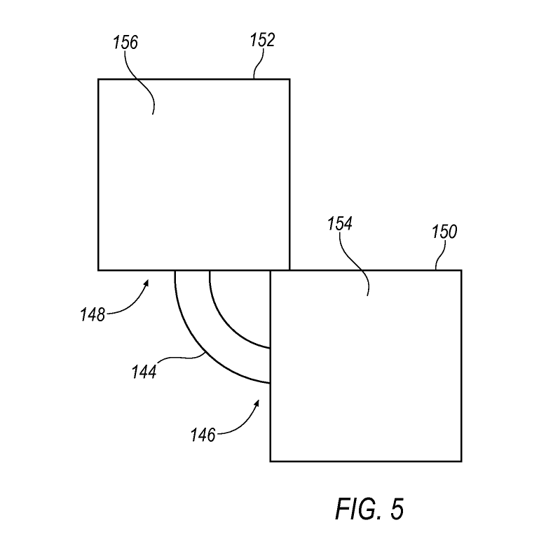

The modular containment units 100 may generally each comprise separate containment units, thereby keeping the contents separate from the other containment units 100. However, referring to FIG. 5, communication (e.g., air or water) may be permitted directly between two modular containment units 100, e.g. via a tunnel or other equipment. This fluid communication may allow fish or wildlife to move between adjacent modular containment units, or may merely allow for circulation of a fluid, e.g., water or air, between the adjacent modular containment units. Thus, a conduit 144 may include a first end 146 and a second end 148, the first end 146 positioned in an open communication with a modular unit 150 and the second end 148 positioned in an open communication with a modular unit 152, such that wildlife can pass from a first wildlife habitat 154 to a second wildlife habitat 156 via conduit 144. In such fashion and as one example, fish or wildlife in general may thereby have a living structure without food as one of the modular units 150, 152, and food may be placed in the other of the modular units 150, 152. Further, although the illustrated conduit 144 is shown connecting beneath wildlife habitat 156, it could instead be used to joint habitats from top to top or side to side. In one example, an upright clear conduit joining two water habitats could be filled with water and, provided both ends stay submerged, would provide a “water tunnel” where fish could swim from one habitat to another, utilizing the principle of positive water pressure.

While the exemplary illustrations above show generally quadrangular modular containment units and tank units 102 thereof, any shapes may be used without limitation. Additionally, although four outer supports 110 are illustrated as supporting the individual tank units 102, any number or configuration of support elements may be used. Merely as an example, a generally cylindrical tank unit (not shown) may be supported by a single vertically extending along an outer surface of the tank unit, or through a portion of the tank unit.

Further, additional exemplary modular containment units may partition the inside of the disclosed habitats to be able to house different species of wildlife and plants and food sources. The disclosed modular containment system can be arranged to have a particular final shape and footprint, to fit a particular space while providing habitats that house different species, to better fit into existing spaces. Also additional equipment like filters and other life supporting apparatus could be used to further the function of the disclosed habitats—either in one habitat or in a series of habitats, further providing separate spaces but clean shared water for part of, or for the whole of the system. Further, life supporting environmental controls or equipment may be included as part of an overall system.

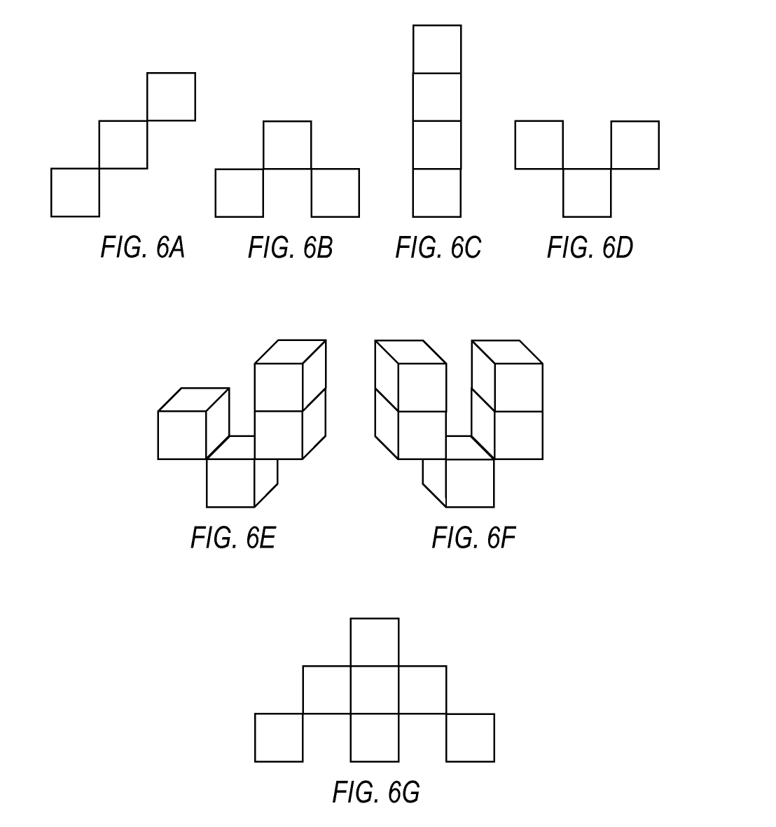

Turning now to FIGS. 6A-6G, a variety of exemplary configurations of the modular containment units, each represented as a square, are illustrated schematically. While the foregoing description in FIGS. 2 and 3 illustrates the modular containment units in a stepped configuration (6A), other configurations are illustrated in examples 6B, 6C, 6D, 6E, 6F, and 6G. Accordingly, a plurality of modular containment units may be configured in a virtually limitless array of ways, allowing pet containment units and/or decorative elements to be placed in a corresponding array of ways in a living space.

In general, the foregoing description is intended to be illustrative and not restrictive. Many embodiments and applications other than the examples provided would be apparent to those of skill in the art upon reading the above description. The scope of the invention should be determined, not with reference to the above description, but should instead be determined with reference to the claims of any subsequent utility application, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation, and is limited only by the claims contained in a relevant subsequent utility application.

What is claimed is:

1. A wildlife containment system, comprising:
a first modular unit positionable on a surface and configured to contain a first wildlife habitat, the first modular unit including a first set of outer supports located at corner regions of the first modular unit;
a second modular unit configured to contain a second wildlife habitat, the second modular unit including a second set of outer supports located at corner regions of the second modular unit; and
a support structure received within apertures in the first and second sets of outer supports, the support structure maintaining the first and second modular units in a fixed relationship such that the second modular unit is supported at least in part by the first modular unit and suspended above the surface.

2. The containment system of claim 1, wherein each of the first and second modular units includes a tank unit that generally encloses a volume therein, the outer supports located at the corner regions of the tank unit and having the apertures, and an upper support that engages the tank unit and the plurality of outer supports, and a base section that.

3. The containment system of claim 1, further comprising one or more support extenders positionable within a base section of the first modular unit and configured to engage the surface and provide support for the first modular unit to prevent the containment system from tipping over.

4. The containment system of claim 1, wherein the support structure includes at least one T-shaped support having a first base member attached to a cross member, the cross member having a first end received within the apertures of the first modular unit and a second end received within the apertures of the second modular unit such that at least a portion of a weight of the second modular unit is supported by the first base member of the T-shaped support.

5. The containment system of claim 4, wherein the support structure includes a second base member that is transverse to the first base member, such that the second base member supports a third modular unit that is configured to contain a third wildlife habitat, the third modular unit supported at least in part by the first modular unit and suspended above the surface.

6. The containment system of claim 1, further comprising a conduit having a first end and a second end, the first end positioned within the first modular unit and the second end positioned within the second modular unit such that wildlife can pass from the first wildlife habitat to the second wildlife habitat via the conduit.

7. The containment system of claim 6, wherein the first wildlife habitat includes a living structure without food, and the second wildlife habitat includes food.

8. The containment system of claim 1, wherein at least one of the first and second modular units is transparent such that wildlife within one of the first and second wildlife habitats is viewable from outside the at least one of the first and second modular units.

9. The containment system of claim 1, wherein at least one of the first and second modular units is configured to include wildlife, wherein the wildlife includes one of a fish and an animal.

10. The containment system of claim 1, wherein one of the first and second modular units is shaped as one of a cube, a cuboid, and a hexagonal prism.

11. A modular containment unit for wildlife, comprising:
a first tank unit having a first volume that defines a first wildlife habitat, the first tank unit positioned on a surface;
a second tank unit having a second volume that defines a second wildlife habitat;
a plurality of outer supports configured to frame the first tank unit and the second tank unit and located at corners thereof; and
a support structure configured to be received in apertures of the outer supports of the first and second tank units to support and suspend the second tank unit above the surface.

12. The modular containment unit of claim 11, wherein each of the first and second modular units includes a tank unit that generally encloses a volume therein, the outer supports located at the corner regions of the tank unit and having the apertures, and an upper support that engages the tank unit and the plurality of outer supports, and a base section that.

13. The modular containment unit of claim 11, further comprising one or more support extenders positionable within a base section of the outer supports and configured to engage the surface and provide support for the first tank unit to prevent the modular containment system from tipping over.

14. The modular containment unit of claim 11, wherein the support structure includes at least one T-shaped support having a first base member attached to a cross member, the cross member having a first end received within the apertures of outer supports of the first tank unit, and a second end received within the apertures of outer supports of the second tank unit, such that at least a portion of a weight of the second tank unit is supported by the first base member of the T-shaped support.

15. The modular containment unit of claim 14, wherein the support structure includes a second base member that is transverse to the first base member such that the second base member is received in apertures within supports of a third tank unit, the third tank unit having a third volume that defines a third wildlife habitat, the third tank unit supported at least in part by the first tank unit and suspended above the surface.

16. The modular containment unit of claim 11, further comprising a conduit having a first end and a second end, the first end positioned within the first tank unit and the second end positioned within the second tank unit such that wildlife can pass from the first wildlife habitat to the second wildlife habitat via the conduit.

17. The modular containment unit of claim 16, wherein the first wildlife habitat includes a living environment without food, and the second wildlife habitat includes food.

18. The modular containment unit of claim 11, wherein at least one of the first and second tank units is transparent such that wildlife within one of the first and second wildlife habitats is viewable from outside the at least one of the first and second tank units.

19. The modular containment unit of claim 11, wherein at least one of the first and second tank units includes wildlife, wherein the wildlife includes one of a fish and an animal.

20. The modular containment unit of claim 11, wherein one of the first and second modular units is shaped as one of a cube, a cuboid, and a hexagonal prism.
